(19) United States
(12) Patent Application Publication
(10) Pub. No.: US 2026/0074112 A1
(43) Pub. Date: Mar. 12, 2026

(54) MULTILAYER CERAMIC CAPACITOR AND METHOD OF MANUFACTURING THE SAME

(71) Applicant: SAMSUNG ELECTRO-MECHANICS CO., LTD., Suwon-si (KR)

(72) Inventors: Sumin Shin, Suwon-si (KR); Sunghwan Lee, Suwon-si (KR); Hongseok Kim, Suwon-si (KR)

(73) Assignee: SAMSUNG ELECTRO-MECHANICS CO., LTD., Suwon-si (KR)

(21) Appl. No.: 19/057,551

(22) Filed: Feb. 19, 2025

(30) Foreign Application Priority Data
Sep. 11, 2024 (KR) 10-2024-0124086

(51) Int. Cl. H01G 4/008; H01G 4/30

(52) U.S. Cl. CPC H01G 4/0085; H01G 4/30

(57) ABSTRACT

A multilayer ceramic capacitor including a capacitor body including a dielectric layer and an internal electrode layer, and an external electrode disposed on an outer surface of the capacitor body, wherein the internal electrode layer includes nickel (Ni), and a space lattice edge length of the nickel (Ni) obtained from Equation 1 through X-ray diffraction analysis (XRD) of the internal electrode layer is about 3.522 Å to about 3.544 Å.

$$α = \frac{λ \cdot \sqrt{{h}^{2} + {k}^{2} + {l}^{2}}}{2 sin θ} \qquad [ Equation 1 ]$$

In Equation 1, λ, h, k, l and θ are as defined in the specification.

### CROSS-REFERENCE TO RELATED APPLICATION

This application claims priority to and the benefit of Korean Patent Application No. 10-2024-0124086 filed in the Korean Intellectual Property Office on Sep. 11, 2024, the entire contents of which are incorporated herein by reference.

### BACKGROUND

### (a) Technical Field

The present disclosure relates to a multilayer ceramic capacitor and a method of manufacturing the same.

### (b) Description of the Related Art

As electronic components using a ceramic material, there are a capacitor, an inductor, a piezoelectric element, a varistor, a thermistor, and the like. Among ceramic electronic components, a multilayer ceramic capacitor (MLCC) may be used in various electronic devices due to advantages such as a small size, a high capacitance, an easy mounting feature, and the like.

For example, a multilayer ceramic capacitor (MLCC) may be used in a chip type condenser mounted on a board of several electronic products such as image devices, for example, liquid crystal displays (LCD), plasma display panels (PDP), or the like, computers, personal portable terminals, smartphones, and the like, to serve to charge or discharge electricity therein or therefrom.

Recent demands for miniaturization and large capacitance of MLCCs require an increase in the number of layers of dielectrics and internal electrodes. As the number of layers increases, the electric field intensity transferred to each layer of the dielectric increases and heat generation increases, which causes problems with durability and reliability.

### SUMMARY

An embodiment provides a multilayer ceramic capacitor having excellent durability and moisture resistance reliability.

Another embodiment provides a method of manufacturing a multilayer ceramic capacitor.

An embodiment provides a multilayer ceramic capacitor including a capacitor body including a dielectric layer and an internal electrode layer, and an outer electrode disposed on an outer surface of the capacitor body, wherein the internal electrode layer includes nickel (Ni), and a space lattice edge length of nickel (Ni) obtained from Equation 1 through X-ray diffraction analysis (XRD) of the internal electrode layer is about 3.522 Å to about 3.544 Å.

$$α = \frac{λ \cdot \sqrt{{h}^{2} + {k}^{2} + {l}^{2}}}{2 sin θ} \qquad [ Equation 1 ]$$

In Equation 1, λ is 1.5406 Å, which is Cu K_{α}, h, k, and l are plane indices, and θ is a Bragg angle.

The dielectric layer may include a barium titanate-based compound.

A difference between the space lattice edge length of nickel (Ni) in the internal electrode layer and the space lattice edge length of the barium titanate-based compound may be about 0.492 Å to about 0.515 Å, and the space lattice edge length of the barium titanate-based compound may be obtained from Equation 1 through X-ray diffraction analysis (XRD) of the dielectric layer.

The internal electrode layer may further include germanium (Ge).

Germanium (Ge) may be disposed inside a lattice of nickel (Ni).

The internal electrode layer may include germanium (Ge) in an amount of 0.95 atomic % to 11.95 atomic % based on a total amount of nickel (Ni) and germanium (Ge).

The internal electrode layer may further include one or more selected from copper (Cu), silver (Ag), palladium (Pd), gold (Au), and an alloy thereof.

The dielectric layer may include germanium (Ge).

An average thickness of the internal electrode layer may be 0.1 μm to 1 μm.

An average thickness of the dielectric layer may be 0.1 μm to 8.0 μm.

Another embodiment provides a method of manufacturing a multilayer ceramic capacitor, including: mixing nickel (Ni) and a germanium (Ge)-based raw material to prepare a conductive paste; manufacturing a dielectric green sheet from a dielectric slurry, and applying the conductive paste on a surface of the dielectric green sheet to form a conductive paste layer; manufacturing a dielectric green sheet stack by stacking a plurality of the dielectric green sheet on which the conductive paste layer is formed; manufacturing a capacitor body including a dielectric layer and an internal electrode layer by firing the dielectric green sheet stack; and forming an external electrode on an outer surface of the capacitor body, wherein the internal electrode layer includes nickel (Ni), a space lattice edge length of nickel (Ni) obtained from Equation 1 through X-ray diffraction analysis (XRD) of the internal electrode layer is 3.522 Å to 3.544 Å.

The germanium (Ge)-based raw material may include Ge, an oxide of Ge, a nitride of Ge, a salt compound of Ge, or a mixture thereof, or the germanium (Ge)-based raw material may include a compound in a form of a sol in which Ge is dispersed in an organic solvent.

The internal electrode layer may include germanium (Ge) in an amount of 0.95 atomic % to 11.95 atomic % based on a total amount of the nickel (Ni) and germanium (Ge) in the internal electrode layer.

Another embodiment provides a method for manufacturing a multilayer ceramic capacitor, including preparing a conductive paste including nickel (Ni); preparing a dielectric slurry including a barium titanate-based compound including barium (Ba), titanium (Ti), and germanium (Ge); manufacturing a dielectric green sheet from a dielectric slurry, and applying the conductive paste on a surface of the dielectric green sheet to form a conductive paste layer; manufacturing a dielectric green sheet stack by stacking a plurality of the dielectric green sheet on which the conductive paste layer is formed; manufacturing a capacitor body including a dielectric layer and an internal electrode layer by firing the dielectric green sheet stack; and forming an external electrode on an outer surface of the capacitor body, wherein the internal electrode layer includes nickel (Ni), and a space lattice edge length of nickel (Ni) obtained from Equation 1 through X-ray diffraction analysis (XRD) of the internal electrode layer is 3.522 Å to 3.544 Å.

Another embodiment provides a method of manufacturing a multilayer ceramic capacitor, including firing a dielectric green sheet stack in a reducing atmosphere that includes hydrogen at a concentration of up to 1% to manufacture a capacitor body including a dielectric layer and an internal electrode layer; and forming an external electrode on an outer surface of the capacitor body, wherein the dielectric green sheet stack includes a plurality of dielectric green sheets and a plurality of conductive paste layers, a conductive paste layer among the plurality of conductive paste layers is disposed on a dielectric green sheet among the plurality of dielectric green sheets, the plurality of conductive paste layers includes nickel (Ni), and a germanium (Ge)-based raw material, the internal electrode layer includes nickel (Ni), a space lattice edge length of nickel (Ni) obtained from Equation 1 through X-ray diffraction analysis (XRD) of the internal electrode layer is 3.522 Å to 3.544 Å.

The germanium (Ge)-based raw material may include GeO₂.

The internal electrode layer may include germanium (Ge) in an amount of 0.95 atomic % to 11.95 atomic % based on a total amount of nickel (Ni) and germanium (Ge).

The firing of the dielectric green sheet stack may be performed at a temperature of 1100° C. to 1400° C., and the reducing atmosphere may have an oxygen partial pressure of 1.0×10⁻¹⁴ MPa to 1.0×10⁻¹⁰ MPa.

The reducing atmosphere may further include nitrogen and moisture.

The dielectric layer may include a barium titanate-based compound.

A difference between the space lattice edge length of nickel (Ni) in the internal electrode layer and the space lattice edge length of the barium titanate-based compound may be about 0.492 Å to about 0.515 Å, and the space lattice edge length of the barium titanate-based compound may be obtained from Equation 1 through X-ray diffraction analysis (XRD) of the dielectric layer.

The multilayer ceramic capacitor according to an embodiment has improved durability and superior moisture resistance reliability due to reduced occurrence of cracks.

### BRIEF DESCRIPTION OF THE DRAWINGS

FIG. 1 is a perspective view showing a multilayer ceramic capacitor according to an embodiment.

FIG. 2 is a cross-sectional view of the multilayer ceramic capacitor taken along line I-I′ of FIG. 1.

FIG. 3 is a cross-sectional view of the multilayer ceramic capacitor taken along line II-II′ of FIG. 1.

FIG. 4 is an exploded perspective view illustrating the stacked structure of the internal electrode layers in the capacitor body of FIG. 1.

FIG. 5 is an XRD (X-ray diffraction analysis) graph of the internal electrode layer manufactured after firing according to Example 3 and the raw powder for forming the internal electrode layer before firing.

FIG. 6 is a graph showing an enlarged portion of the Ni (220) portion among the XRD results for the internal electrode layer manufactured after firing according to Example 3 and the raw powder for forming the internal electrode layer before firing.

FIG. 7A is a SEM micrograph of the internal electrode layer according to Example 3, and FIG. 7B is a SEM-EDS (scanning electron microscope-energy dispersive spectroscopy) analysis diagram of the internal electrode layer according to Example 3.

### DETAILED DESCRIPTION

Hereinafter, the present disclosure will be described in detail hereinafter with reference to the accompanying drawings, in which embodiments of the present disclosure are shown. The drawings and description are to be regarded as illustrative in nature and not restrictive. Like reference numerals designate like elements throughout the specification. In the accompanying drawings, some components are exaggerated, omitted, or schematically illustrated, and the size of each component does not entirely reflect the actual size.

The accompanying drawings are intended only to facilitate an understanding of the embodiments disclosed in this specification, and it is to be understood that the technical ideas disclosed herein are not limited by the accompanying drawings and include all modifications, equivalents, or substitutions that are within the range of the ideas and technology of the present disclosure.

Although terms of “first,” “second,” and the like are used to explain various components, the components are not limited to such terms. These terms are only used to distinguish one component from another component.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be positioned above or below the reference element, and it is not necessarily referred to as being positioned “on” or “above” in a direction opposite to gravity.

Throughout the specification, the terms “comprise” or “have” are intended to specify the presence of stated features, integers, steps, operations, components, components or a combination thereof, but do not preclude the presence or addition of one or more other features, integers, steps, operations, components, components, and/or groups thereof. Therefore, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

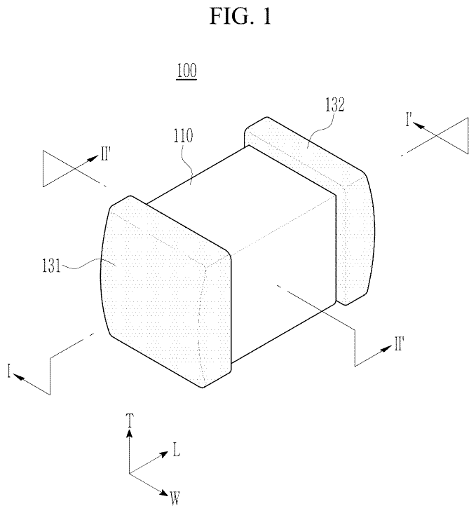

Hereinafter, a multilayer ceramic capacitor according to an embodiment will be described with reference to FIGS. 1 to 4.

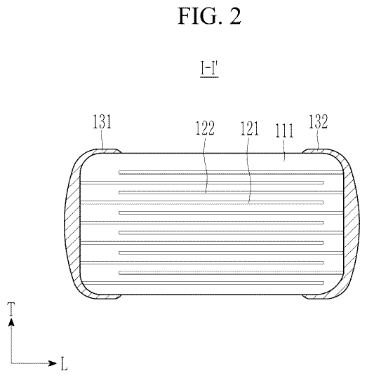

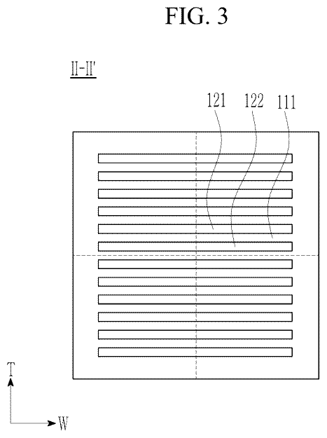

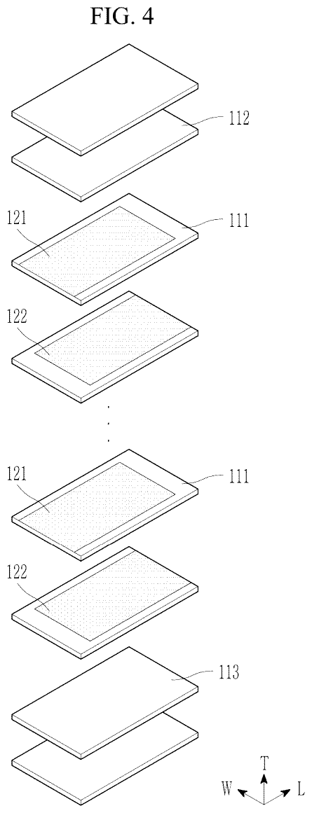

FIG. 1 is a perspective view showing a multilayer ceramic capacitor according to an embodiment, FIG. 2 is a cross-sectional view of a multilayer ceramic capacitor taken along line I-I′ of FIG. 1, FIG. 3 is a cross-sectional view of a multilayer ceramic capacitor taken along line II-II′ of FIG. 1, and FIG. 4 is an exploded perspective view illustrating the stacked structure of the internal electrode layers in the capacitor body of FIG. 1.

The L-axis, W-axis, and T-axis shown in FIGS. 1 to 4 represent a length direction, a width direction, and a thickness direction of a capacitor body 110, respectively. Here, the thickness direction (T-axis direction) may be a direction perpendicular to the wide surface (major surface) of the sheet-shaped components, and may be used as the same concept as a stacking direction in which a dielectric layer 111 are stacked, for example. The length direction (L-axis direction) may be a direction extending parallel to the wide surface (major surface) of the sheet-shaped components, and may be approximately perpendicular to the thickness direction (T-axis direction). For example, the length direction (L-axis direction) may be the direction in which an external electrode 131 and a second external electrode 132 are positioned. The width direction (W-axis direction) may be a direction extending parallel to the wide surface (major surface) of the sheet-shaped components, and may be approximately perpendicular to the thickness direction (T-axis direction) and the length direction (L-axis direction). The length of the sheet-shaped components in the length direction (L-axis direction) may be longer than the length in the width direction (W-axis direction).

Referring to FIGS. 1 to 4, a multilayer ceramic capacitor 100 according to an embodiment includes the capacitor body 110 and external electrodes 131 and 132 disposed outer surface the capacitor body 110. The external electrodes 131 and 132 may include a first external electrode 131 and a second external electrode 132 disposed at opposite ends of the capacitor body 110 in the length direction (L-axis direction).

For example, the capacitor body 110 may have a roughly hexahedral shape.

For convenience of description of an embodiment, the two surfaces opposing each other in the thickness direction (T-axis direction) of the capacitor body 110 are referred to as first and second surfaces, the two surfaces connected to the first and second surfaces and opposing each other in the length direction (L-axis direction) are referred to as third and the fourth surfaces, and two surfaces connected to the first and second surfaces and to the third and fourth surfaces, and opposing each other in the width direction (W-axis direction) are referred to as the fifth and sixth surfaces.

As an example, the first surface, which is the lower surface, may be a surface facing the mounting direction. Additionally, the first to the sixth surfaces may be flat, but the embodiment is not limited thereto. For example, the first to the sixth surfaces may be curved surfaces with a convex central portion, and the edges, which are the boundaries of each surface, may be rounded.

The shape and size of the capacitor body 110 and the number of stacks of the dielectric layers 111 are not limited to those shown in the drawings of the embodiment.

The capacitor body 110 includes a plurality of dielectric layers 111 and internal electrode layers 121 and 122. Specifically, the capacitor body 110 includes the plurality of dielectric layers 111 and a first internal electrode layer 121 and a second internal electrode layer 122 alternately disposed in the thickness direction (T-axis direction) interposing the dielectric layer 111.

At this time, the boundaries between adjacent dielectric layers 111 of the capacitor body 110 may be integrated to the extent that it is difficult to check without using a scanning electron microscope (SEM).

The capacitor body 110 may include an active region and cover regions 112 and 113.

The active region is a region where the dielectric layer 111 and the internal electrode layers 121 and 122 are alternately disposed, which contributes to forming capacitance of the multilayer ceramic capacitor 100. Specifically, the active region may be a region where the first internal electrode layer 121 or the second internal electrode layer 122 stacked along the thickness direction (T-axis direction) overlap.

The cover regions 112 and 113 are thickness-direction marginal portions, and may be positioned on the first and second surfaces of the active region in the thickness direction (T-axis direction), respectively. The cover regions 112 and 113 may be a single dielectric layer 111 or two or more dielectric layers 111 stacked on the upper and lower surfaces of the active region, respectively.

Additionally, the capacitor body 110 may further include a side margin region.

The side margin region is a width-direction margin portion and may be located on opposite side ends of the active region in the width direction (W-axis direction), that is, on the fifth surface and the sixth surface, respectively. The side margin region may be formed according as, when the conductive paste layer for the internal electrode is applies on a surface of a dielectric green sheet, the dielectric green sheets, which are applied with the conductive paste layer only in a partial region of the surface of the dielectric green sheet and not applied with the conductive paste layer on both side surfaces of the surface of the dielectric green sheet, are stacked and then fired, but the forming method is not limited thereto.

The cover regions 112 and 113 and the side margin region serve to prevent damage to the first internal electrode layer 121 and the second internal electrode layer 122 due to physical or chemical stress.

Hereinafter, each of the internal electrode layer, dielectric layer, and outer electrode is described in detail.

### Internal Electrode Layer

The internal electrode layers 121 and 122, i.e., the first internal electrode layer 121 and the second internal electrode layer 122, are electrodes having different polarities and are alternately arranged to face each other along the T-axis direction with the dielectric layer 111 interposed between them, and one end may be exposed through the third and fourth surfaces of the capacitor body 110, respectively.

The first internal electrode layer 121 and the second internal electrode layer 122 may be electrically insulated from each other by a dielectric layer 111 disposed in the middle.

The ends of the first internal electrode layer 121 and the second internal electrode layer 122, which are alternately exposed through the third and fourth surfaces of the capacitor body 110, may be electrically connected to the first external electrode 131 and the second external electrode 132, respectively.

According to an embodiment, the first internal electrode layer 121 and the second internal electrode layer 122 may include nickel (Ni) as a conductive metal.

From the X-ray diffraction analysis (XRD) results for the internal electrode layers 121 and 122 containing nickel (Ni), the space lattice edge length of nickel (Ni) can be obtained by Bragg's law. In other words, the space lattice edge length of nickel (Ni) according to an embodiment can be obtained by Bragg's law from the Ni peak appearing in the XRD results for the internal electrode layer according to an embodiment.

Specifically, the Bragg angle θ is obtained by using the position 2θ of the Ni peak appearing on the XRD graph for the internal electrode layer according to an embodiment, and the interplanar distance is calculated using the Bragg angle, thereby obtaining the space lattice edge length of Ni. Other methods and/or tools appreciated by one of ordinary skill in the art, even if not described in the present disclosure, may also be used.

According to an embodiment, the space lattice edge length of nickel (Ni) obtained from Equation 1 may be about 3.522 Å to about 3.544 Å, for example, about 3.523 Å to about 3.543 Å, about 3.524 Å to about 3.542 Å, or about 3.525 Å to about 3.541 Å. When the space lattice edge length of nickel (Ni) in the internal electrode layer according to an embodiment is within the above range, a displacement difference between the internal electrode layer and the dielectric layer and the barium titanate-based compound of the dielectric layer at the interface between the internal electrode layer and the dielectric layer is reduced, and accordingly, the occurrence of cracks in the multilayer ceramic capacitor including the entire active region, the cover region, and the side margin region can be reduced, and specifically, the occurrence of cracks at the interface between the internal electrode layer and the dielectric layer in the active region can be reduced. Therefore, not only is the durability of the multilayer ceramic capacitor improved, but it can also have excellent moisture resistance reliability.

$$α = \frac{λ \cdot \sqrt{{h}^{2} + {k}^{2} + {l}^{2}}}{2 sin θ} \qquad [ Equation 1 ]$$

In Equation 1, λ is 1.5406 Å, which is Cu K_{α}, h, k, and l are plane indices, and θ is the Bragg angle.

In more detail, after the multilayer ceramic capacitor 100 was placed into the epoxy mixture liquid and then cured, the W-axis and the T-axis directional surface (WT surface) of the capacitor body 110 was polished to ½ depth in the L-axis direction, and then by fixing and maintaining it in the vacuum atmosphere chamber, a cross-sectional sample may be obtained such that the active region where the dielectric layer 111 and the internal electrode layers 121 and 122 intersect may be observed. Next, X-ray diffraction analysis (XRD) is performed using Cu K_{α} rays for the internal electrode layers 121 and 122 among the active regions of the cross-sectional sample, and the space lattice edge length of the nickel (Ni) can be calculated from the results by Bragg's law. For example, the space lattice edge length of nickel (Ni) can be obtained by dividing the active region of a cross-sectional sample into three equal parts, the upper part, the middle part, and the lower part, and then taking three points within the internal electrode layer for each area, and taking the average value from a total of nine points.

According to an embodiment, the first internal electrode layer 121 and the second internal electrode layer 122 may further include germanium (Ge). Since the internal electrode layer includes germanium (Ge) together with nickel (Ni), the space lattice edge length of Ni is increased, so that a displacement difference between Ni in the internal electrode layer and the barium titanate-based compound in the dielectric layer at the interface between the internal electrode layer and the dielectric layer can be reduced.

Specifically, germanium (Ge) may be included in a form dissolved inside nickel (Ni) within the internal electrode layers 121 and 122.

In the XRD results for the internal electrode layer according to an embodiment, a single peak of germanium (Ge) may not appear.

In other words, the space lattice edge length of nickel (Ni) obtained from the X-ray diffraction analysis (XRD) results for the internal electrode layers 121 and 122 according to an embodiment of the present disclosure is different from the space lattice edge length of Ni alone in a general simple cubic structure, as Ge is dissolved inside the lattice of Ni, and specifically, may have a length that is increased compared to the latter.

Generally, multilayer ceramic capacitors have internal electrode layers and dielectric layers made of different materials. That is, the internal electrode layer is mainly composed of Ni, and the dielectric layer is mainly composed of BaTiO₃. The space lattice of BaTiO₃ transits to a tetragonal structure below about 130° C., which forms a difference in the space lattice edge length compared to Ni in a simple cubic structure. The space lattice edge length of Ni in a general simple cubic structure (a=b=c) is approximately 3.520 Å, and in the case of BaTiO₃ in a tetragonal structure (a=b≠c), the horizontal and vertical edge lengths are approximately 3.995 Å, and the height length is approximately 4.036 Å. That is, Ni and BaTiO₃ have a difference in space lattice displacement of up to 0.516 Å.

This displacement difference makes it difficult to form bonds between the atoms that make up the dielectric layer and the internal electrode layer, which causes the electric field to be concentrated at the stacked interface, that is, the interface between the dielectric layer and the internal electrode layer, and weakens the moisture resistance reliability. In addition, the atomic mismatch interface between the dielectric layer and the internal electrode layer may cause crack formation.

According to an embodiment, since the space lattice edge length of nickel (Ni) obtained from the XRD results for the internal electrode layers 121 and 122 according to an embodiment has a length that is increased compared to the space lattice edge length of general Ni, the displacement difference between Ni of the internal electrode layer and the barium titanate-based compound of the dielectric layer at the interface between the internal electrode layer and the dielectric layer can be reduced. Accordingly, occurrence of cracks within the multilayer ceramic capacitor, specifically occurrence of cracks at the interface between the internal electrode layer and the dielectric layer, is minimized, thereby improving durability and providing excellent moisture resistance reliability.

For example, the difference between the space lattice edge length of nickel (Ni) in the internal electrode layers 121 and 122 and the space lattice edge length of the barium titanate-based compound in the dielectric layer, i.e., the displacement difference, may be about 0.492 Å to about 0.515 Å, for example, about 0.493 Å to about 0.514 Å, about 0.494 Å to about 0.513 Å, or about 0.495 Å to about 0.512 Å. The space lattice edge length of the barium titanate-based compound can be obtained from Equation 1 through X-ray diffraction analysis (XRD) of the dielectric layer 111. Other methods and/or tools appreciated by one of ordinary skill in the art, even if not described in the present disclosure, may also be used. When the displacement difference between nickel (Ni) and barium titanate-based compound is within the above range, the occurrence of cracks within the multilayer ceramic capacitor, specifically, the occurrence of cracks at the interface between the internal electrode layer and the dielectric layer, is minimized, thereby improving durability and providing excellent moisture resistance reliability.

The germanium (Ge) may be included in the internal electrode layers 121 and 122 in an amount of about 0.95 atomic % to about 11.95 atomic %, for example, about 0.98 atomic % to about 11.5 atomic %, about 1.0 atomic % to about 11.0 atomic %, about 1.3 atomic % to about 10.5 atomic %, or about 1.5 atomic % to about 10.0 atomic % based on a total amount of nickel (Ni) and germanium (Ge). When germanium (Ge) is included in the internal electrode layer within the above content range, it can induce an increase in the space lattice edge length of Ni, thereby reducing the displacement difference between Ni in the internal electrode layer and the barium titanate-based compound in the dielectric layer at the interface between the internal electrode layer and the dielectric layer. Accordingly, occurrence of cracks within the multilayer ceramic capacitor, specifically occurrence of cracks at the interface between the internal electrode layer and the dielectric layer, can be reduced, and durability and moisture resistance reliability can be improved.

The germanium (Ge) in the internal electrode layers 121 and 122 may be derived from a material added to the conductive paste when forming the internal electrode layer, or may be derived from some of the Ge included in the composition of the dielectric layer moving to the internal electrode layer.

The first internal electrode layer 121 and the second internal electrode layer 122 may further include one or more selected from among copper (Cu), silver (Ag), palladium (Pd), gold (Au), and an alloy thereof, as a conductive metal, in addition to nickel (Ni).

Additionally, the first internal electrode layer 121 and the second internal electrode layer 122 may further include dielectric particles having the same composition as the ceramic material included in the dielectric layer 111.

The presence and content of nickel (Ni) and germanium (Ge) within the internal electrode layers 121 and 122 can be confirmed by SEM-EDS (scanning electron microscope-energy dispersive spectroscopy) analysis. Other methods and/or tools appreciated by one of ordinary skill in the art, even if not described in the present disclosure, may also be used.

In more detail, after the multilayer ceramic capacitor 100 was placed into the epoxy mixture liquid and then cured, the W-axis and the T-axis directional surface (WT surface) of the capacitor body 110 was polished to ½ depth in the L-axis direction, and then by fixing and maintaining it in the vacuum atmosphere chamber, a cross-sectional sample may be obtained such that the active region where the dielectric layer 111 and the internal electrode layers 121 and 122 intersect may be observed. Next, the active region of the cross-sectional sample can be measured using a transmission electron microscope (TEM) so that at least one layer of the dielectric layer and the internal electrode layer are visible, for example, one to ten layers. For example, SEM can be measured at 10 kV using a Verios G4 from Thermofisher Scientific in a region of approximately 6 μm×6 μm, where six dielectric layers and six internal electrode layers are visible in the active region. Next, by performing EDS (energy dispersive spectroscopy) analysis on the internal electrode layer through the SEM image of the measured cross-sectional sample, the presence and content of Ni, Ge, etc. in the internal electrode layers 121 and 122 can be confirmed. For example, the contents of Ni, Ge, etc. according to an embodiment can be obtained by dividing the active region of the cross-sectional sample into three equal parts, upper, middle, and lower, during the EDS point analysis, by taking three points within the internal electrode layer for each area and taking the average value from a total of nine points.

The first internal electrode layer 121 and the second internal electrode layer 122 can be formed using a conductive paste including a conductive metal including nickel (Ni) and optionally a germanium (Ge)-based raw material. The printing method for the conductive paste may be either screen printing or gravure printing.

An average thickness of the first internal electrode layer 121 and the second internal electrode layer 122 may be about 0.1 μm to about 2 μm, for example about 0.1 μm to about 1 μm. When the average thickness of the internal electrode layers 121 and 122 is within the above range, the reliability of the multilayer ceramic capacitor is excellent.

The average thickness of the first internal electrode layer 121 and the second internal electrode layer 122 may be measured by placing the multilayer ceramic capacitor 100 in an epoxy mixing solution, curing it, polishing it, and then ion milling it, and then analyzing it using a scanning electron microscope (SEM). A scanning electron microscope can be used, for example, using a Verios G4 product from Thermofisher Scientific, with measurement conditions of 10 kV and 0.2 nA, an analysis magnification of 100 times, and may be measured for at least 1 layer, 3 layers, 5 layers, or 10 layers or more of internal electrode layers 121 and 122. In a scanning electron microscope (SEM) image of a measured cross-sectional sample, the central point in the length direction (L-axis direction) or the width direction (W-axis direction) of the first internal electrode layer 121 or the second internal electrode layer 122 is used as a reference point, and the arithmetic mean value of the thickness of the first internal electrode layer 121 or the second internal electrode layer 122 at 10 points spaced apart from the reference point by a predetermined interval can be obtained. The spacing between the 10 points can be adjusted according to the scale of the scanning electron microscope (SEM) image, and can be, for example, about 1 μm to about 100 μm, about 1 μm to about 50 μm, or about 1 μm to about 10 μm. At this time, all 10 points should be located within the first internal electrode layer 121 or the second internal electrode layer 122, and if all 10 points are not located within the first internal electrode layer 121 or the second internal electrode layer 122, the location of the reference point can be changed or the interval between the 10 points can be adjusted. Other methods and/or tools appreciated by one of ordinary skill in the art, even if not described in the present disclosure, may also be used.

### Dielectric Layer

According to an embodiment, the dielectric layer 111 may include a barium titanate-based compound including barium (Ba) and titanium (Ti) as a main component.

The barium titanate-based compound is a dielectric base material, have high permittivity, and contribute to forming the permittivity of multilayer ceramic capacitors 100.

For example, the barium titanate-based compound may include at least one selected from BaTiO₃, Ba(Ti, Zr)O₃, Ba(Ti, Sn)O₃, (Ba, Ca)TiO₃, (Ba, Ca)(Ti, Zr)O₃, (Ba, Ca)(Ti, Sn)O₃, (Ba, Sr)TiO₃, (Ba, Sr)(Ti, Zr)O₃ and (Ba, Sr)(Ti, Sn)O₃.

According to an embodiment, the dielectric layer 111 may include germanium (Ge). Specifically, the barium titanate-based compound may further include germanium (Ge) in addition to barium (Ba) and titanium (Ti). For example, germanium (Ge) may be dissolved inside the lattice of the barium titanate-based compound (e.g., BaTiO₃).

An average thickness (average length in the T-axis direction) of the dielectric layer 111 may be about 2.0 μm to about 8.0 μm, and for example, may be about 0.1 μm to about 6.0 μm. When the average thickness of the dielectric layer 111 is within the above range, the reliability of the multilayer ceramic capacitor may be improved.

This may be an arithmetic mean value obtained by taking the central point of the length direction (L-axis direction) or width direction (W-axis direction) of the dielectric layer 111 as a reference point in a scanning electron microscope (SEM) image of a cross-sectional sample measured as described above, and taking the arithmetic mean value of the thickness of the dielectric layer 111 at 10 points spaced apart from the reference point at a predetermined interval. The intervals of the 10 points may be adjusted depending on the scale of the SEM image, and may be, for example, about 1 μm to about 100 μm, about 1 μm to about 50 μm, or about 1 μm to about 10 μm. At this time, all 10 points must be positioned within the dielectric layer 111, and if all 10 points are not positioned within the dielectric layer 111, the position of the reference point may be changed, or the interval between the 10 points may be adjusted. Other methods and/or tools appreciated by one of ordinary skill in the art, even if not described in the present disclosure, may also be used.

The capacitor body 110 may be formed by firing a stacking structure in which the plurality of dielectric layers 111 and internal electrode layers 121 and 122 are stacked.

### External Electrode

The first external electrode 131 and the second external electrode 132 are provided with voltages of different polarities and may be electrically connected with exposed portions of the first internal electrode layer 121 and the second internal electrode layer 122, respectively.

According to the above configuration, when a predetermined voltage is applied to the first external electrode 131 and the second external electrode 132, charges are accumulated between the first internal electrode layer 121 and the second internal electrode layer 122 facing each other. At this time, the capacitance of the multilayer ceramic capacitor 100 is proportional to the overlapping area of the first internal electrode layer 121 and the second internal electrode layer 122 that overlap each other along the T-axis direction in the active region.

The first external electrode 131 and the second external electrode 132 may include, respectively, first and second connection portions disposed on the third and fourth surfaces of the capacitor body 110 and connected to the first internal electrode layer 121 and the second internal electrode layer 122, and first and second band portions disposed on edges where the third and fourth surfaces of the capacitor body 110 meet the first and second surfaces or the fifth and sixth surfaces.

The first and second band portions may extend, respectively, from the first and second connection portions to portions of the first and second surfaces of the capacitor body 110 or the fifth and sixth surfaces. The first and second band portions may serve to improve the adhesion strength of the first external electrode 131 and the second external electrode 132.

Each of the first external electrode 131 and the second external electrode 132 may include a sintered metal layer in contact with the capacitor body 110, a conductive resin layer disposed to cover the sintered metal layer, and a plating layer disposed to cover the conductive resin layer.

The sintered metal layer may include the conductive metal and glass.

The conductive metal may include one or more selected from copper (Cu), nickel (Ni), silver (Ag), palladium (Pd), gold (Au), platinum (Pt), tin (Sn), tungsten (W), titanium (Ti), lead (Pb), and an alloy thereof, for example, copper (Cu) may include a copper (Cu) alloy. When the conductive metal includes copper (Cu), metals other than copper (Cu) may be included in an amount of less than or equal to about 5 parts by mole based on 100 parts by mole of copper (Cu).

The glass may include a composition of mixed oxides, for example, one or more selected from the group consisting of silicon oxide, boron oxide, aluminum oxide, transition metal oxide, alkali metal oxide, and alkaline earth metal oxide. The transition metal may be selected from a group consisting of zinc (Zn), titanium (Ti), copper (Cu), vanadium (V), manganese (Mn), iron (Fe) and nickel (Ni), the alkali metal may be selected from a group consisting of lithium (Li), sodium (Na) and potassium (K), and the alkaline-earth metal may be at least one selected from a group consisting of magnesium (Mg), calcium (Ca), strontium (Sr) and barium (Ba).

Optionally, the conductive resin layer may be formed on the sintered metal layer, and for example, may be formed in the shape that completely covers the sintered metal layer. Meanwhile, the first external electrode 131 and the second external electrode 132 may not include the sintered metal layer, and in this case, the conductive resin layer may directly contact the capacitor body 110.

The conductive resin layer extends to the first and second surfaces or the fifth and sixth surfaces of the capacitor body 110, and the length of the region (i.e., band portion) where the conductive resin layer is extended and disposed to the first and second surfaces or the fifth and sixth surfaces of the capacitor body 110 may be longer than the length of the region (i.e., band portion) where the sintered metal layer is extended and disposed to the first and second surfaces or the fifth and sixth surfaces of the capacitor body 110. That is, the conductive resin layer may be formed on the sintered metal layer, and may be formed in the shape that completely covers the sintered metal layer.

The conductive resin layer may include a resin and a conductive metal.

The resin included in the conductive resin layer may be implemented by a material which has adhesive properties and shock absorption properties and is able to form a paste when mixed with the conductive metal powder, but is not limited thereto. For example, the resin may include a phenolic resin, an acrylic resin, a silicone resin, an epoxy resin, or a polyimide resin.

The conductive metal included in the conductive resin layer serves to be electrically connected to the first internal electrode layer 121 and the second internal electrode layer 122 or the sintered metal layer.

The conductive metal included in the conductive resin layer may have a spherical shape, a flake shape, or a combination thereof. That is, the conductive metal may be formed only in flake form, only in spherical form, or in a mixed form of flake form and spherical form.

Here, the spherical shape may also include a shape that is not a perfect spherical shape, for example, a shape in which the length ratio of the major axis and the minor axis (major axis/minor axis) is less than or equal to about 1.45. The flake shape powder refers to a powder with a flat and elongated shape, and is not particularly limited. But for example, the length ratio of the major axis and the minor axis (major axis/minor axis) may be greater than or equal to about 1.95.

The first external electrode 131 and the second external electrode 132 may further include the plating layer disposed outer surface the conductive resin layer.

The plating layer may include nickel (Ni), copper (Cu), tin (Sn), palladium (Pd), platinum (Pt), gold (Au), silver (Ag), tungsten (W), titanium (Ti), or lead (Pb), either alone or in an alloy thereof. For example, the plating layer may be a nickel (Ni) the plating layer or a tin (Sn) the plating layer, may be a form in which the nickel (Ni) the plating layer and the tin (Sn) the plating layer are sequentially stacked, or may be a form in which the tin (Sn) the plating layer, the nickel (Ni) the plating layer, and the tin (Sn) the plating layer are sequentially stacked. In addition, the plating layer may include a plurality of nickel (Ni) the plating layers and/or a plurality of tin (Sn) the plating layers.

The plating layer may improve mountability to the substrate, structural reliability, durability to the outer surface, heat resistance, and equivalent series resistance (ESR) of the multilayer ceramic capacitor 100.

### Method for Manufacturing Multilayer Ceramic Capacitor

Hereinafter, a method of manufacturing the multilayer ceramic capacitor 100 according to an embodiment will be described.

A multilayer ceramic capacitor 100 according to an embodiment may be manufactured by preparing a conductive paste including nickel (Ni); manufacturing a dielectric green sheet using a dielectric slurry, and printing the conductive paste on a surface of the dielectric green sheet to form a conductive paste layer; manufacturing a dielectric green sheet stack by stacking the dielectric green sheet on which the conductive paste layer is formed; manufacturing a capacitor body including a dielectric layer and an internal electrode layer by firing the dielectric green sheet stack; and forming an external electrode on an outer surface of the capacitor body.

A conductive paste for forming an internal electrode layer can be prepared by mixing a germanium (Ge)-based raw material with nickel (Ni). When forming an internal electrode layer using a germanium (Ge)-based raw material, not only can Ni be obtained in the form of Ge being dissolved within the Ni lattice, but also an increase in the space lattice edge length of the obtained Ni can be induced.

The germanium (Ge)-based raw material may be Ge, an oxide of Ge, a nitride of Ge, a salt compound of Ge, or a compound in the form of a sol in which Ge is dispersed in an organic solvent.

The germanium (Ge)-based raw material may be included in an amount such that Ge is included in an amount of about 0.95 atomic % to about 11.95 atomic %, for example, about 0.98 atomic % to about 11.5 atomic %, about 1.0 atomic % to about 11.0 atomic %, about 1.3 atomic % to about 10.5 atomic %, or about 1.5 atomic % to about 10.0 atomic % based on the total amount of nickel (Ni) and germanium (Ge)-based raw materials. When the germanium (Ge)-based raw material is mixed within the above content range, the space lattice edge length of Ni in the internal electrode layer is increased, thereby reducing the displacement difference between Ni in the internal electrode layer and the barium titanate-based compound in the dielectric layer at the interface between the internal electrode layer and the dielectric layer. Accordingly, a multilayer ceramic capacitor with minimized occurrence of cracks and excellent durability and moisture resistance reliability can be obtained.

In addition to nickel (Ni), the conductive paste may be prepared by further mixing one or more conductive metals selected from copper (Cu), silver (Ag), palladium (Pd), gold (Au), and an alloy thereof.

In addition, the conductive paste may be prepared by additionally mixing a binder and a solvent. Additionally, barium titanate-based powder may be mixed in as a co-material if necessary. The co-material may act to inhibit the sintering of the conductive powder during the firing process.

A dielectric slurry may be prepared by mixing a barium titanate-based compound as a main component powder and optionally a subcomponent powder.

The barium titanate-based compound may include barium (Ba) and titanium (Ti) and optionally germanium (Ge).

The subcomponent powder may include a compound including a rare earth element, a transition metal element, etc. The subcomponent powder may be, for example, an oxide, nitride, salt compound of a rare earth element, a transition metal element, or a compound in the form of a sol dispersed in an organic solvent.

The dielectric slurry may be prepared by additionally mixing additives such as a dispersant, a binder, a plasticizer, a lubricant, an antistatic agent, and a solvent.

The dispersant may include at least one selected from, for example, a phosphoric acid ester-based dispersant and a polycarboxylic acid-based dispersant. The dispersant may be mixed in an amount of about 0.1 part by weight to about 5 parts by weight, for example, about 0.3 parts by weight to about 3 parts by weight based on 100 parts by weight of the barium titanate-based compound. When the dispersant is mixed within the above content range, the dielectric slurry shows excellent dispersibility, and the amount of impurities included in the manufactured dielectric layer may be reduced.

The binder may be, for example, an acrylic resin, a polyvinyl butyl resin, a polyvinyl acetal resin, an ethylcellulose resin, or the like. The binder may be added in an amount of about 0.1 part by weight to about 50 parts by weight, for example, about 3 parts by weight to about 30 parts by weight, based on 100 parts by weight of the barium titanate-based compound. When the binder is mixed within the above content range, the dielectric slurry shows excellent dispersibility, and the amount of impurities included in the manufactured dielectric layer may be reduced.

The plasticizer may be, for example, a phthalic acid-based compound such as dioctyl phthalate, benzyl butyl phthalate, dibutyl phthalate, dihexyl phthalate, di(2-ethylhexyl) phthalate, and di(2-ethylbutyl) phthalate; an adipic acid-based compound such as dihexyl adipate and di(2-ethylhexyl) adipate; a glycol-based compound such as ethylene glycol, diethylene glycol, and triethylene glycol; a glycol ester-based compound such as triethylene glycol dibutyrate, triethylene glycol di(2-ethylbutyrate), and triethylene glycol di(2-ethylhexanoate); and the like. The plasticizer may be added in an amount of about 0.1 part by weight to about 20 parts by weight, for example, about 1 part by weight to about 10 parts by weight, based on 100 parts by weight of the barium titanate-based compound. When the plasticizer is mixed within the above content range, the dielectric slurry shows excellent dispersibility, and the amount of impurities included in the manufactured dielectric layer may be reduced.

The solvent may be an aqueous solvent such as water; an alcohol-based solvent such as ethanol, methanol, benzyl alcohol, and methoxyethanol; a glycol-based solvent such as ethylene glycol and diethylene glycol; a ketone-based solvent such as acetone, methyl ethyl ketone, methyl isobutyl ketone, and cyclohexanone; an ester-based solvent such as butyl acetate, ethyl acetate, carbitol acetate, and butylcarbitol acetate; an ether-based solvent such as methyl cellosolve, ethyl cellosolve, butyl ether, and tetrahydrofuran; an aromatic-based solvent such as benzene, toluene, and xylene, or the like. The solvent may be, for example, an alcohol-based solvent or aromatic-based solvent, considering solubility or dispersibility of various additives included in the dielectric slurry. The solvent may be mixed in an amount of about 50 parts by weight to about 1000 parts by weight, and for example, about 100 parts by weight to about 500 parts by weight based on 100 parts by weight of the barium titanate-based compound. When the solvent is mixed within the above content range, the dielectric slurry components may be sufficiently mixed, and subsequent removal of the solvent is easy.

The dielectric slurry described above may be mixed by using a wet ball mill or a stirred mill. When using the zirconia balls in the wet ball mill, a plurality of zirconia balls with a diameter of about 0.1 mm to about 10 mm may be used for wet mixing for about 8 hours to about 48 hours, or about 10 hours to about 24 hours.

The prepared dielectric slurry is formed into a dielectric layer after firing. As a method of molding the prepared the dielectric slurry into a sheet shape, a tape molding method such as a doctor blade method, a calendar roll method, etc. may be used, for example, an on-roll molding coater with a head discharge method, and a dielectric green sheet may be obtained by drying the molded body afterward.

In the step of manufacturing the dielectric green sheet, a dielectric slurry may be prepared by mixing a barium titanate-based compound as a main component powder and optionally a subcomponent powder.

Next, a dielectric green sheet stack is manufactured by stacking a plurality of layers of dielectric green sheets on which internal electrode patterns are formed, and then pressing the plurality of layers of dielectric green sheets in the stacking direction. At this time, the dielectric green sheet and the internal electrode pattern may be stacked so that the dielectric green sheet is positioned on the upper and lower surfaces of the dielectric green sheet stack in the stacking direction.

The cutting of the manufactured dielectric green sheet stack to a predetermined size by dicing or the like may optionally be performed.

Additionally, the dielectric green sheet stack may be solidified and dried to remove plasticizers, etc., if necessary, and after solidified and dried, the dielectric green sheet stack may be barrel polished using a horizontal centrifugal barrel machine, and the like. In barrel polishing, the dielectric green sheet stack is placed into a barrel container with media and polishing liquid, and rotational motion or vibration is applied to the barrel container, thus unnecessary parts, such as burrs generated during cutting, may be polished. Additionally, after barrel polishing, the dielectric green sheet stack may be washed with a cleaning solution such as water, and dried.

Subsequently, the capacitor body may be prepared after binder removal treatment (calcining) and firing of the dielectric green sheet stack.

The conditions for binder removal may be appropriately adjusted depending on the components of the dielectric layer or the internal electrode layer. For example, the rate of temperature rise during binder removal treatment may be about 5° C./hour to about 300° C./hour, the support temperature may be about 180° C. to about 400° C., and the temperature holding time may be about 0.5 hour to about 24 hours. The binder removal may be performed under an air atmosphere or a reducing atmosphere.

The conditions of the firing treatment may be appropriately adjusted depending on the main component composition of the dielectric layer or the main component composition of the internal electrode layer. For example, the firing may be performed at a temperature of about 1100° C. to about 1400° C., for example, at a temperature of about 1200° C. to about 1350° C. Additionally, the firing may be performed for about 0.5 to about 8 hours, for example, about 1 to about 3 hours. Additionally, the firing may be performed in a reducing atmosphere, for example, in a humidified mixed gas of nitrogen and hydrogen, and may be performed under conditions such as a hydrogen concentration of less than or equal to about 1.0%. When the internal electrode layer includes nickel (Ni) or a nickel (Ni) alloy, an oxygen partial pressure under the firing atmosphere may be about 1.0×10⁻¹⁴ MPa to about 1.0×10⁻¹⁰ MPa.

After firing, annealing may be performed as needed. The annealing is a treatment to re-oxidize the dielectric layer, and annealing may be performed if firing is performed in a reducing atmosphere. The conditions of the annealing treatment may also be appropriately adjusted depending on the components of the dielectric layer. For example, the annealing temperature may be about 950° C. to about 1150° C., the time may be about 0 to about 20 hours, and the rate of temperature rise may be about 50° C./hour to about 500° C./hour. The annealing atmosphere may be a humidified nitrogen gas (N₂) atmosphere, and an oxygen partial pressure may be about 1.0×10⁻⁹ MPa to about 1.0×10⁻⁵ MPa.

In binder removal treatment, firing treatment, or annealing treatment, for example, a wetter may be used to humidify nitrogen gas or mixed gas. In this case, the water temperature may be about 5° C. to about 75° C. The binder removal treatment, firing treatment, and annealing treatment may be performed sequentially or independently.

Optionally, surface treatment such as sand blasting, laser irradiation, barrel polishing, etc. may be performed on the third and fourth surfaces of the prepare capacitor body 110. By performing this surface treatment, the ends of the first internal electrode layer and the second internal electrode layer may be exposed to the outermost surfaces of the third and fourth surfaces, and thus the electrical connection between the first external electrode layer and the second external electrode layer, and the first internal electrode and the second internal electrode may be improved, alloy portions may be easily formed.

Subsequently, the external electrode is formed on the one surface of the manufactured capacitor body 110.

As an example, a paste for forming the sintered metal layer may be applied to the external electrode and then sintered to form the sintered metal layer.

The paste for forming the sintered metal layer may include the conductive metal and glass. Since the description of the conductive metal and glass is the same as described above, repetitive description will be omitted. Additionally, the paste for forming the sintered metal layer may optionally include a binder, solvent, dispersant, plasticizer, oxide powder, and the like. The binder may be, for example, ethylcellulose, acrylic, butyral, etc., and the solvent may be, for example, an organic solvent or aqueous solvent such as terpineol, butylcarbitol, alcohol, methyl ethyl ketone, acetone, toluene, and the like.

Methods for applying the paste for forming the sintered metal layer on the outer surface of the capacitor body 110 may include various printing methods such as dip method and screen printing, application method using a dispenser, etc., and spraying method using spray. The paste for forming the sintered metal layer may be applied to at least the third and fourth surfaces of the capacitor body 110, and optionally applied to a part of the first, second, fifth, or the sixth surfaces on which the band portions of the first and second external electrodes are formed.

Thereafter, the capacitor body 110 applied with the paste for forming the sintered metal layer is dried, and sintered at a temperature of about 700° C. to about 1000° C. for about 0.1 hour to about 3 hours, to form the sintered metal layer.

Optionally, a paste for forming the conductive resin layer is applied on an outer surface of the obtained capacitor body 110 and then cured, to form the conductive resin layer.

The paste for forming the conductive resin layer may include a resin and, optionally, a conductive metal or a non-conductive filler. Since the description of the conductive metal and resin is the same as described above, repetitive description will be omitted. Additionally, the paste for forming the conductive resin layer may optionally include a binder, a solvent, a dispersant, a plasticizer, an oxide powder, and the like. The binder may be, for example, ethylcellulose, acrylic, butyral, etc., and the solvent may be an organic solvent or aqueous solvent such as terpineol, butylcarbitol, alcohol, methyl ethyl ketone, acetone, and toluene.

For example, the conductive resin layer may be formed by dipping the capacitor body 110 in the paste for forming the conductive resin layer and then curing it, or by printing the paste for forming the conductive resin layer on the surface of the capacitor body 110 by a screen-printing method or a gravure printing method, or by applying the paste for forming the conductive resin layer to the surface of the capacitor body 110 and then curing it.

Next, the plating layer is formed on the outer surface of the conductive resin layer.

For example, the plating layer may be formed by a plating method, sputtering, or electrolytic plating (electric deposition).

Hereinafter, the embodiments are illustrated in more detail with reference to examples. However, these examples are exemplary, and the scope of claims is not limited thereto.

### (Manufacturing of Multilayer Ceramic Capacitors)

### Examples 1 to 7

A conductive paste was prepared by mixing nickel (Ni) and germanium dioxide (GeO₂). At this time, GeO₂ was mixed in an amount such that Ge was in the atomic % range shown in Table 1 based on the total amount of Ni and Ge.

Next, a dielectric slurry was prepared using barium titanate (BaTiO₃) powder. At this time, the dielectric slurry was prepared by mechanical milling after adding ethanol/toluene, a dispersant, and a binder together using zirconia balls (ZrO₂ balls) as a dispersion medium.

Subsequently, the prepared dielectric slurry was used to manufacture a dielectric green sheet by using a head discharge type on-roll forming coater. The conductive paste prepared above was printed on the surface of the dielectric green sheet to form a conductive paste layer.

A dielectric green sheet stack was manufactured by stacking and pressing dielectric green sheets having a conductive paste layer formed thereon.

The dielectric green sheet stack was calcinated at 400° C. or less under a nitrogen atmosphere and fired at 1300° C. or less at a hydrogen (H₂) concentration of 1.0% or less.

Subsequently, the dielectric green sheet stack was used to manufacture a multilayer ceramic capacitor through processes of an external electrode, plating, or the like.

### Comparative Example 1

A multilayer ceramic capacitor was manufactured in the same manner as in Example 1 except that the conductive paste was prepared by using Ni alone.

### Comparative Example 2

A multilayer ceramic capacitor was manufactured in the same manner as in Example 1 except that GeO₂ was mixed by using 0.55 atomic % of Ge based on the total amount of Ni and Ge in Example 1.

### Comparative Example 3

A multilayer ceramic capacitor was manufactured in the same manner as in Example 1 except that GeO₂ was mixed by using 14.50 atomic % of Ge based on the total amount of Ni and Ge in Example 1.

TABLE 1
In Table 1, each Ge content is expressed based
on the total atomic weight of Ni and Ge.

| | Ge content (atomic %) |
|---|---|
| Example 1 | 0.95 |
| Example 2 | 1.84 |
| Example 3 | 2.05 |
| Example 4 | 4.80 |
| Example 5 | 7.80 |
| Example 6 | 9.75 |
| Example 7 | 11.95 |
| Comparative Example 1 | 0 |
| Comparative Example 2 | 0.55 |
| Comparative Example 3 | 14.50 |

### Evaluation 1: XRD Analysis

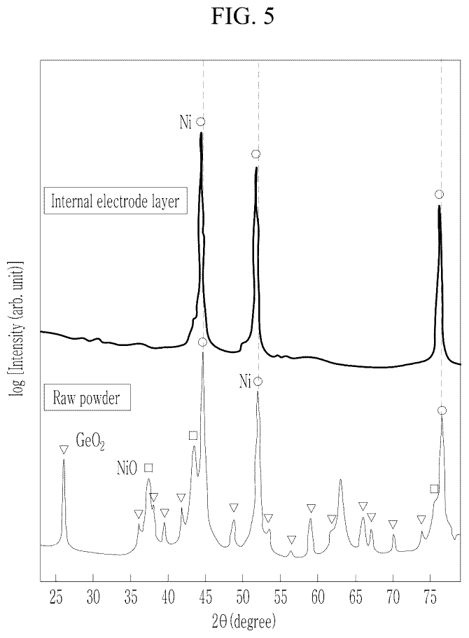

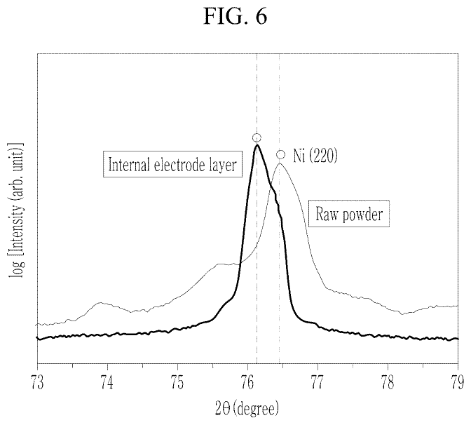

The internal electrode layers in multilayer ceramic capacitors of Examples 1 to 7 and Comparative Examples 1 to 3 were subjected to an X-ray diffraction analysis (XRD), and the results are shown in FIGS. 5 and 6 and Table 2.

Specifically, the XRD analysis was performed on the internal electrode layer of the multilayer ceramic capacitor manufactured after firing in Example 3 and the raw powder used to form the internal electrode layer before the firing in Example 3, and the results are shown in FIGS. 5 and 6.

Specifically, after the multilayer ceramic capacitor was put in an epoxy mixing solution and cured, a W-axis and T-axis direction surface (WT surface) of its capacitor body was polished to a ½ depth in a L-axis direction and maintained in a vacuum atmosphere chamber, obtaining a cross-sectional sample to examine an active region where an dielectric layer and internal electrode layer intersect each other. Subsequently, the X-ray diffraction analysis (XRD) was performed on the internal electrode layer in the active region of the cross-sectional sample by using Cu K_{α} rays, and the result was used to calculate a space lattice edge length of nickel (Ni) as follows. Specifically, the space lattice edge length of nickel (Ni) was obtained by dividing the active region of the cross-sectional sample into three portions of upper, middle, and lower portions, taking three points in each portion in the internal electrode layer, and calculating an average value from total nine points.

In addition, the raw powder was prepared into a pellet by mixing Ni and GeO₂ for the measurement.

FIG. 5 is an XRD (X-ray diffraction analysis) graph of the internal electrode layer manufactured after firing according to Example 3 and the raw powder for forming the internal electrode layer before the firing, and FIG. 6 is a graph showing an enlarged portion of the Ni (220) portion among the XRD results for the internal electrode layer manufactured after the firing according to Example 3 and the raw powder for forming the internal electrode layer before firing.

Referring to FIG. 5, the XRD measurement result for the raw powder according to Example 3 exhibited peaks of Ni, NiO on the surface of Ni, and GeO₂, but the XRD measurement result for the internal electrode layer prepared after the firing according to Example 3 exhibited a peak of Ni alone. This may be seen as GeO₂ reduced to Ge during the firing process and then, dissolved inside Ni.

In addition, referring to FIG. 5, the Ni peak of the raw powder in XRD, compared to the Ni peak of the internal electrode layer in XRD, was shifted relatively to the right. Furthermore, referring to FIG. 6, the Ni peak of the raw powder to that of the internal electrode layer after the firing was relatively shifted to the left. This may be seen to cause Ge inside the space lattice of Ni of the internal electrode layer to increase an edge length of the space lattice. Accordingly, compared with the internal electrode layer formed of Ni alone as raw powder in Comparative Example 1, the internal electrode layer formed of the raw powder consisting of Ni and GeO₂ in Example 3 exhibited that the space lattice edge length of Ni increased.

On the other hand, the space lattice edge length of Ni was obtained by using a position 2θ of the Ni peak of the internal electrode layer in an XRD graph to obtain a Bragg angle θ and using the Bragg angle to calculate an interplanar distance. Specifically, the space lattice edge length of Ni was calculated according to Equation 1 by using the measurements obtained through the XRD analysis of each of the internal electrode layers according to Examples 1 to 7 and Comparative Examples 1 to 3, and the results are shown in Table 2.

$$α = \frac{λ \cdot \sqrt{{h}^{2} + {k}^{2} + {l}^{2}}}{2 sin θ} \qquad [ Equation 1 ]$$

In Equation 1, λ is 1.5406 Å, which is Cu K_{α}, h, k, and l are plane indices, and θ is the Bragg angle.

In addition, the dielectric layers in multilayer ceramic capacitors according to Examples 1 to 7 and Comparative Examples 1 to 3 were subjected to an X-ray diffraction analysis (XRD), and the space lattice edge length of BaTiO₃ was calculated according to Equation 1 by using the measurement obtained through the XRD analysis. Subsequently, a difference between the space lattice edge length of Ni and the space lattice edge length of BaTiO₃ was calculated, and the results are shown in Table 2.

Referring to Table 2, each space lattice edge length of Ni in the internal electrode layers according to Examples 1 to 7 was within a range of 3.522 Å to 3.544 Å.

Specifically, in Comparative Example 1, the space lattice edge length of Ni was 3.520 Å, and in Example 3, the space lattice edge length of Ni was 3.526 Å. In other words, in Example 3, compare with Comparative Example 1, the space lattice edge length of Ni increased by 0.006 Å and in addition, exhibited a reduced difference by 0.006 Å from the space lattice edge length of BaTiO₃ in the dielectric layer.

### Evaluation 2: SEM-EDS Analysis

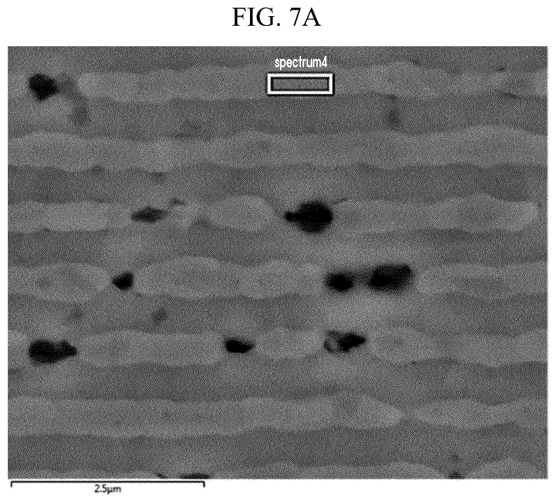

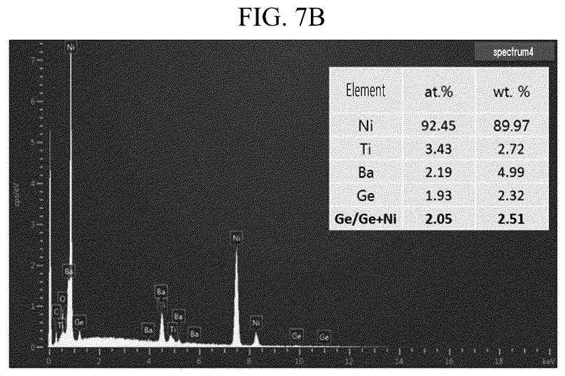

The multilayer ceramic capacitors according to Examples 1 to 7 and Comparative Examples 1 to 3 were subjected to an SEM-EDS (scanning electron microscope-energy dispersive spectroscopy) analysis, and the results are shown in Table 2 and FIGS. 7A and 7B.

Specifically, the multilayer ceramic capacitors manufactured in Examples 1 to 7 and Comparative Examples 1 to 3 were placed into an epoxy mixture and cured, and the W-axis and T-axis direction surface (WT surface) of each capacitor body was polished to a depth of ½ in the L-axis direction and then, fixed and maintained in a vacuum atmosphere chamber to obtain cross-sectional samples to observe an active region where a dielectric layer and an internal electrode layer intersect each other. Subsequently, the active region of the cross-sectional sample was measured with a scanning electron microscope (SEM) to ensure that at least dielectric layers and internal electrode layers were visible. The SEM measurement was performed in an area of about 6 μm×6 μm where at least 6 dielectric layers and internal electrode layers were respectively visible in the active region by using Verios G4 manufactured by Thermofisher Scientific Inc. under a condition of 10 kV. Subsequently, the SEM image of each of the cross-sectional samples was used to perform the EDS (energy dispersive spectroscopy) analysis for the internal electrode layer and thus calculate contents of Ni, Ge, and the like in the internal electrode layer. Specifically, the active region of the cross-sectional sample was divided into 3 portions of upper, central, and lower portions to take 3 points from each portion in the internal electrode layer and obtain an average value of each of the contents of Ni, Ge, and the like at 9 points in total.

Any point in the internal electrode layer was subjected to an EDS (energy dispersive spectroscopy) analysis.

FIG. 7A is a SEM micrograph of the internal electrode layer according to Example 3, and FIG. 7B is a SEM-EDS (scanning electron microscope-energy dispersive spectroscopy) analysis diagram of the internal electrode layer according to Example 3.

Referring to FIGS. 7A and 7B, the internal electrode layer of Example 3 was confirmed to include nickel (Ni) and germanium (Ge), wherein the germanium (Ge) was included in an amount of 2.05 atomic % based on a total amount of Ni and Ge. In addition, Ge was dissolved within Ni. Some Ba and Ti detected in the internal electrode layer were elements constituting the dielectric layer and thus regarded to move toward the internal electrode layer, wherein the Ba and Ti unlike Ge were not dissolved in the internal electrode layer, referring to the XRD results of FIG. 5.

In addition, referring to Table 2, the internal electrode layers of Examples 1 to 7 included nickel (Ni) and germanium (Ge), wherein the germanium (Ge) was included within a range of 0.95 atomic % to 11.95 atomic % based on a total amount of Ni and Ge. On the contrary, the internal electrode layer of Comparative Example 1 included no germanium (Ge), and the internal electrode layers of Comparative Examples 2 and 3 included the germanium (Ge) out of the predetermined range.

TABLE 2

| | | | Difference in space |
|---|---|---|---|
| | | | lattice edge length |
| | | Space lattice | between Ni in |
| | Ge content | edge length of | the internal |
| | in internal | Ni in the | electrode layer and |
| | electrode | internal | BaTiO₃ in the |
| | layer | electrode layer | dielectric |
| | (atomic %) | (Å) | layer (Å) |
| Example 1 | 0.95 | 3.522 | 0.514 |
| Example 2 | 1.84 | 3.525 | 0.511 |
| Example 3 | 2.05 | 3.526 | 0.510 |
| Example 4 | 4.80 | 3.530 | 0.506 |
| Example 5 | 7.80 | 3.536 | 0.500 |
| Example 6 | 9.75 | 3.540 | 0.496 |
| Example 7 | 11.95 | 3.544 | 0.492 |
| Comparative | 0 | 3.520 | 0.516 |
| Example 1 | | | |
| Comparative | 0.55 | 3.521 | 0.515 |
| Example 2 | | | |
| Comparative | 14.50 | 3.557 | 0.479 |
| Example 3 | | | |

### Evaluation 3: Moisture Resistance Reliability

The moisture resistance reliability of multilayer ceramic capacitors according to Examples 1 to 7 and Comparative Examples 1 to 3 were measured, and the results are shown in Table 3.

Specifically, each of the multilayer ceramic capacitors according to Examples 1 to 7 and Comparative Examples 1 to 3 was manufactured by 10000 and then, mounted on a measurement substrate to measure moisture resistance reliability under the conditions of 85° C., relative humidity (R.H.) of 85%, 6.5 V, and 500 hours by using ESPEC (PR-3J, 8585) equipment.

As a result of the moisture resistance reliability measurement, a multilayer ceramic capacitor, which had IR (insulation resistance) of less than or equal to 1×10⁴ Ohm, was judged as defective to calculate a defective rate (%) based on the 10000 multilayer ceramic capacitors.

Referring to Table 3, Examples 1 to 7 which had the space lattice edge length of Ni in the internal electrode layer within the range of 3.522 Å to 3.544 Å range, compared with Comparative Examples 1 to 3, exhibited excellent moisture resistance reliability.

### Evaluation 4: Occurrence of Cracks

The occurrence of cracks in multilayer ceramic capacitors according to Examples 1 to 7 and Comparative Examples 1 to 3 were measured, and the results are shown in Table 3.

Specifically, each of the multilayer ceramic capacitors according to Examples 1 to 7 and Comparative Examples 1 to 3 was manufactured by 100 and cured in an epoxy mixture, and then, its capacitor body was polished on the W-axis and T-axis direction surface (WT surface) to a ½ depth in a L-axis direction, obtaining a cross-sectional sample. Subsequently, the cross-sectional sample was examined with a scanning electron microscope (SEM) over all the regions such as an active region, a cover region, and a side margin region to check whether or not cracks occurred. The SEM measurement was performed by using Verios G4 made by Thermofisher Scientific Inc. under a condition of 10 kV. As a result of the measurement, a product, in which cracks occurred in any one region among all the regions, was judged as defective, wherein the cracks were determined to be those with a major length of 10 nm or more. The number of products judged as defective based on a total of 100 is shown in Table 3.

Referring to Table 3, Examples 1 to 7 having the space lattice edge length of Ni in the internal electrode layer within the range of 3.522 Å to 3.544 Å, compared with Comparative Examples 1 to 3, exhibited a decrease in the crack occurrence.

TABLE 3

| | Moisture resistance | Occurrence of cracks |
|---|---|---|
| | reliability defect rate | Number of defective |
| | (%) | products |
| Example 1 | 0.6 | 1 |
| Example 2 | 0.0 | 0 |
| Example 3 | 0.0 | 0 |
| Example 4 | 0.1 | 0 |
| Example 5 | 0.1 | 0 |
| Example 6 | 0.4 | 1 |
| Example 7 | 0.8 | 1 |
| Comparative Example 1 | 11.0 | 13 |
| Comparative Example 2 | 6.5 | 8 |
| Comparative Example 3 | 9.5 | 9 |

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A multilayer ceramic capacitor, comprising
a capacitor body including a dielectric layer and an internal electrode layer, and
an external electrode disposed on an outer surface of the capacitor body,
wherein the internal electrode layer includes nickel (Ni), and
a space lattice edge length of nickel (Ni) obtained from Equation 1 through X-ray diffraction analysis (XRD) of the internal electrode layer is 3.522 Å to 3.544 Å:
$$α = \frac{λ \cdot \sqrt{{h}^{2} + {k}^{2} + {l}^{2}}}{2 sin θ} \qquad [ Equation 1 ]$$
wherein, in Equation 1:
λ is 1.5406 Å, which is Cu K_{α},
h, k, and l are plane indices, and
θ is a Bragg angle.

2. The multilayer ceramic capacitor of claim 1, wherein
the dielectric layer includes a barium titanate-based compound.

3. The multilayer ceramic capacitor of claim 2, wherein
a difference between the space lattice edge length of nickel (Ni) in the internal electrode layer and a space lattice edge length of the barium titanate-based compound is 0.492 Å to 0.515 Å, and
the space lattice edge length of the barium titanate-based compound is obtained from Equation 1 through X-ray diffraction analysis (XRD) of the dielectric layer.

4. The multilayer ceramic capacitor of claim 1, wherein
the internal electrode layer further includes germanium (Ge).

5. The multilayer ceramic capacitor of claim 4, wherein
germanium (Ge) is disposed inside a lattice of nickel (Ni).

6. The multilayer ceramic capacitor of claim 4, wherein
the internal electrode layer includes germanium (Ge) in an amount of 0.95 atomic % to 11.95 atomic % based on a total amount of nickel (Ni) and germanium (Ge).

7. The multilayer ceramic capacitor of claim 1, wherein
the internal electrode layer further includes one or more selected from copper (Cu), silver (Ag), palladium (Pd), gold (Au), and an alloy thereof.

8. The multilayer ceramic capacitor of claim 1, wherein
the dielectric layer includes germanium (Ge).

9. The multilayer ceramic capacitor of claim 1, wherein
an average thickness of the internal electrode layer is 0.1 μm to 1 μm.

10. The multilayer ceramic capacitor of claim 1, wherein
an average thickness of the dielectric layer is 0.1 μm to 8.0 μm.

11. A method of manufacturing a multilayer ceramic capacitor, comprising
mixing nickel (Ni) and a germanium (Ge)-based raw material to prepare a conductive paste;
manufacturing a dielectric green sheet from a dielectric slurry, and applying the conductive paste on a surface of the dielectric green sheet to form a conductive paste layer;
manufacturing a dielectric green sheet stack by stacking a plurality of the dielectric green sheet on which the conductive paste layer is formed;
manufacturing a capacitor body including a dielectric layer and an internal electrode layer by firing the dielectric green sheet stack; and
forming an external electrode on an outer surface of the capacitor body,
wherein the internal electrode layer includes nickel (Ni), and
a space lattice edge length of nickel (Ni) obtained from Equation 1 through X-ray diffraction analysis (XRD) of the internal electrode layer is 3.522 Å to 3.544 Å:
$$α = \frac{λ \cdot \sqrt{{h}^{2} + {k}^{2} + {l}^{2}}}{2 sin θ} \qquad [ Equation 1 ]$$
wherein, in Equation 1:
λ is 1.5406 Å, which is Cu K_{α},
h, k, and l are plane indices, and
θ is a Bragg angle.

12. The method of claim 11, wherein
the germanium (Ge)-based raw material includes Ge, an oxide of Ge, a nitride of Ge, a salt compound of Ge, or a mixture thereof, or
the germanium (Ge)-based raw material includes a compound in a form of a sol in which Ge is dispersed in an organic solvent.

13. The method of claim 11, wherein
the internal electrode layer includes germanium (Ge) in an amount of 0.95 atomic % to 11.95 atomic % based on a total amount of nickel (Ni) and germanium (Ge) in the internal electrode layer.

14. A method of manufacturing a multilayer ceramic capacitor, comprising
preparing a conductive paste including nickel (Ni);
preparing a dielectric slurry including a barium titanate-based compound including barium (Ba), titanium (Ti), and germanium (Ge);
manufacturing a dielectric green sheet from a dielectric slurry, and applying the conductive paste on a surface of the dielectric green sheet to form a conductive paste layer;
manufacturing a dielectric green sheet stack by stacking a plurality of the dielectric green sheet on which the conductive paste layer is formed;
manufacturing a capacitor body including a dielectric layer and an internal electrode layer by firing the dielectric green sheet stack; and
forming an external electrode on an outer surface of the capacitor body,
the internal electrode layer includes nickel (Ni), and
a space lattice edge length of nickel (Ni) obtained from Equation 1 through X-ray diffraction analysis (XRD) of the internal electrode layer is 3.522 Å to 3.544 Å:
$$α = \frac{λ \cdot \sqrt{{h}^{2} + {k}^{2} + {l}^{2}}}{2 sin θ} \qquad [ Equation 1 ]$$
wherein, in Equation 1:
λ is 1.5406 Å, which is Cu K_{α},
h, k, and l are plane indices, and
θ is a Bragg angle.

15. A method of manufacturing a multilayer ceramic capacitor, comprising
firing a dielectric green sheet stack in a reducing atmosphere that includes hydrogen at a concentration of up to 1% to manufacture a capacitor body including a dielectric layer and an internal electrode layer; and
forming an external electrode on an outer surface of the capacitor body,
wherein the dielectric green sheet stack includes a plurality of dielectric green sheets and a plurality of conductive paste layers,
a conductive paste layer among the plurality of conductive paste layers is disposed on a dielectric green sheet among the plurality of dielectric green sheets,
the plurality of conductive paste layers includes nickel (Ni), and a germanium (Ge)-based raw material,
the internal electrode layer includes nickel (Ni), and
a space lattice edge length of nickel (Ni) obtained from Equation 1 through X-ray diffraction analysis (XRD) of the internal electrode layer is 3.522 Å to 3.544 Å:
$$α = \frac{λ \cdot \sqrt{{h}^{2} + {k}^{2} + {l}^{2}}}{2 sin θ} \qquad [ Equation 1 ]$$
wherein, in Equation 1:
λ is 1.5406 Å, which is Cu K_{α},
h, k, and l are plane indices, and
θ is a Bragg angle.

16. The method of claim 15, wherein
the germanium (Ge)-based raw material includes GeO₂.

17. The method of claim 16, wherein
the internal electrode layer includes germanium (Ge) in an amount of 0.95 atomic % to 11.95 atomic % based on a total amount of nickel (Ni) and germanium (Ge) in the internal electrode layer.

18. The method of claim 16, wherein
the firing of the dielectric green sheet stack is performed at a temperature of 1100° C. to 1400° C., and
the reducing atmosphere has an oxygen partial pressure of 1.0×10⁻¹⁴ MPa to 1.0×10⁻¹⁰ MPa.

19. The method of claim 16, wherein
the reducing atmosphere further includes nitrogen and moisture.

20. The method of claim 16, wherein
the dielectric layer includes a barium titanate-based compound.

21. The method of claim 20, wherein
a difference between the space lattice edge length of nickel (Ni) in the internal electrode layer and a space lattice edge length of the barium titanate-based compound is 0.492 Å to 0.515 Å, and
the space lattice edge length of the barium titanate-based compound is obtained from Equation 1 through X-ray diffraction analysis (XRD) of the dielectric layer.
